(19) United States
(12) Patent Application Publication
(10) Pub. No.: US 2025/0240114 A1
(43) Pub. Date: Jul. 24, 2025

(54) ANTENNA TUNER WITH JAMMER REJECTION

(71) Applicant: QUALCOMM Incorporated, San Diego, CA (US)

(72) Inventors: Sree Venkatesh THATAVARTHY, Bangalore (IN); Ankur AGRAWAL, Bengaluru (IN); Omprakash PRASAD, Bangalore (IN)

(21) Appl. No.: 18/420,257

(22) Filed: Jan. 23, 2024

(51) Int. Cl. H04K 3/00; H04B 1/00; H04B 1/10

(52) U.S. Cl. CPC H04K 3/20; H04B 1/006; H04B 1/1018

(57) ABSTRACT

Certain aspects of the present disclosure provide techniques for jammer rejection at an antenna tuner. An example apparatus includes a first filter comprising at least one reactive component. The apparatus further includes an antenna tuner comprising a capacitor bank selectively coupled in parallel with the at least one reactive component. The apparatus further includes a first set of switches coupled to at least the first filter, wherein the first set of switches is configured to switch among at least a first mode and a second mode, wherein the first mode is configured to bypass the first filter across a signal path, and the second mode is configured to apply the first filter across the signal path.

### INTRODUCTION

### Field of the Disclosure

Aspects of the present disclosure relate to wireless communications, and more particularly, to jammer signal rejection.

### DESCRIPTION OF RELATED ART

Wireless communications systems are widely deployed to provide various telecommunication services such as telephony, video, data, messaging, broadcasts, etc. These wireless communications systems may employ multiple-access technologies capable of supporting communications with multiple users by sharing available wireless communications system resources with those users. Wireless communication devices may communicate RF signals via any of various suitable radio access technologies (RATs) including, but not limited to, 5G New Radio (NR), Evolved Universal Terrestrial Radio Access (E-UTRA), Code Division Multiple Access (CDMA), Time Division Multiple Access (TDMA), Wideband CDMA (WCDMA), Global System for Mobility (GSM), Bluetooth, Bluetooth Low Energy (BLE), ZigBee, wireless local area network (WLAN) RATs (e.g., Institute of Electrical and Electronics Engineers (IEEE) 802.11 specifications), any future RAT, and/or the like.

In certain cases, a wireless communications device is equipped with a radio frequency (RF) transceiver (also referred to as an RF front-end) for communicating RF signals. In general, a baseband signal is modulated to convey information using a modulation technique, such as phase-shift keying (PSK) or any other suitable modulation technique. In a transmit mode, the RF transceiver is responsible for multiplexing the baseband signal with an RF carrier signal that is transmitted over the air (e.g., a wireless communication channel). Such an operation is called upconversion. In a receive mode, the RF transceiver converts a received RF signal to the baseband signal. Such an operation is called downconversion. The received baseband signal then can be demodulated into the information encoded at a transmitter. The RF transceiver may include a cascade of discrete components in a transmit chain and a receive chain, respectively. The cascade of components may include, for example, one or more of attenuators, switches, couplers, filters, mixers, amplifiers, frequency synthesizers, oscillators, antenna tuners, duplexers, diplexers, detectors, etc.

Although there have been great technological advancements in RF circuitry over many years, challenges still exist. For example, RF circuitry can still encounter interference and/or noise. Accordingly, there is a continuous desire to improve the technical performance of RF circuitry, such as interference and/or noise cancellation or suppression.

### SUMMARY

Some aspects provide an apparatus. The apparatus includes a first filter comprising at least one reactive component. The apparatus further includes an antenna tuner comprising a capacitor bank selectively coupled in parallel with the at least one reactive component. The apparatus further includes a first set of switches coupled to at least the first filter, wherein the first set of switches is configured to switch among at least a first mode and a second mode, wherein the first mode is configured to bypass the first filter across a signal path, and the second mode is configured to apply the first filter across the signal path.

Some aspects provide a radio frequency (RF) chain circuit. The circuit comprising: a first filter comprising at least one reactive component; an antenna tuner comprising a capacitor bank selectively coupled in parallel with the at least one reactive component; a first set of switches coupled to at least the first filter, wherein the first set of switches is configured to switch among at least a first mode and a second mode, wherein the first mode is configured to bypass the first filter across a signal path, and the second mode is configured to apply the first filter across the signal path; an amplifier having an input selectively coupled to an output of the antenna tuner; a second filter having an output selectively coupled to the amplifier; and a second set of switches coupled to at least the second filter, wherein the second set of switches is configured to switch among at least the first mode and the second mode, wherein the first mode further bypasses the second filter between the antenna tuner and the amplifier, and the second mode further couples the output of the second filter to input of the amplifier.

Some aspects provide a method of suppressing a jammer signal in a radio frequency (RF) receive chain circuit. The method includes outputting, in response to detecting a jammer signal, a first control signal that triggers a first set of switches to switch from a first mode to a second mode. The method further includes filtering a signal using a first filter while the first set of switches is in the second mode, wherein the first filter comprises at least one reactive component, wherein an antenna tuner comprises a capacitor bank selectively coupled in parallel with the at least one reactive component, and wherein the first set of switches is coupled to at least the first filter.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 illustrates an example wireless communications system.

FIG. 2 illustrates an example wireless communication device communicating with another device.

FIG. 3 illustrates an example radio frequency (RF) receive chain circuit with jammer rejection available at an antenna tuner.

FIG. 4 illustrates an example antenna tuner with selective jammer rejection.

FIG. 5 illustrates an example equivalent circuit of the antenna tuner described with respect to FIG. 4 in a jammer rejection mode.

FIG. 6 illustrates the antenna tuner of FIG. 4 configured in bypass mode.

FIG. 7 illustrates example operations for applying or bypassing jammer rejection at an antenna tuner.

FIG. 8 illustrates an example frequency response of the forward voltage gain (S₂₁) observed at an antenna tuner with jammer rejection enabled.

FIG. 9 illustrates example operations for suppressing a jammer signal in an RF receive chain circuit.

FIG. 10 illustrates a communications device that may include various components configured to perform operations for the techniques disclosed herein.

To facilitate understanding, identical reference numerals have been used, where possible, to designate identical elements that are common to the figures. It is contemplated that elements disclosed in one aspect may be beneficially utilized in other aspects without specific recitation.

### DETAILED DESCRIPTION

Aspects of the present disclosure provide apparatus, methods, processing systems, and computer-readable mediums corresponding to an antenna tuner with jammer rejection.

An RF receiver can encounter interference from various sources, such as internal or external sources. Interference can affect the performance of an RF receiver, for example, in terms of demodulation performance. Internal interference may be encountered due to a wireless communication device supporting full duplex communications and/or multiple radio access technologies (RATs). Transmit signals output at an internal RF transmitter of a device may leak into a receive path of the same device, for example, due to finite attenuation of a duplexer circuit or other RF isolation circuitry. In some cases, the interference may be referred to as a jammer signal or jammer. An RF receiver may employ techniques for jammer detection and rejection in order to mitigate the effects of a jammer signal on a received RF signal. For example, a low noise amplifier (LNA) of an RF receiver may be configured to detect a jammer signal and trigger jammer rejection via a bandpass filter bank, which may include acoustic wave filters.

Technical problems for jammer rejection include, for example, a filter architecture that is effective at suppressing or rejecting a jammer signal. In some cases, the filter architecture may be configured to suppress or reject a jammer signal (e.g., an interfering RF signal) and a third harmonic local oscillator frequency (3FLO) of the jammer signal (referred to herein as “the third harmonic”). The third harmonic may be encountered due to transmit-side RF energy leaking onto the receiver path, such as energy leakage from a mixer or frequency synthesizer. Thus, the filter may have a relatively high quality factor and multiple narrow passbands, for example, at the jammer signal and the third harmonic in order to suppress or reject such interference.

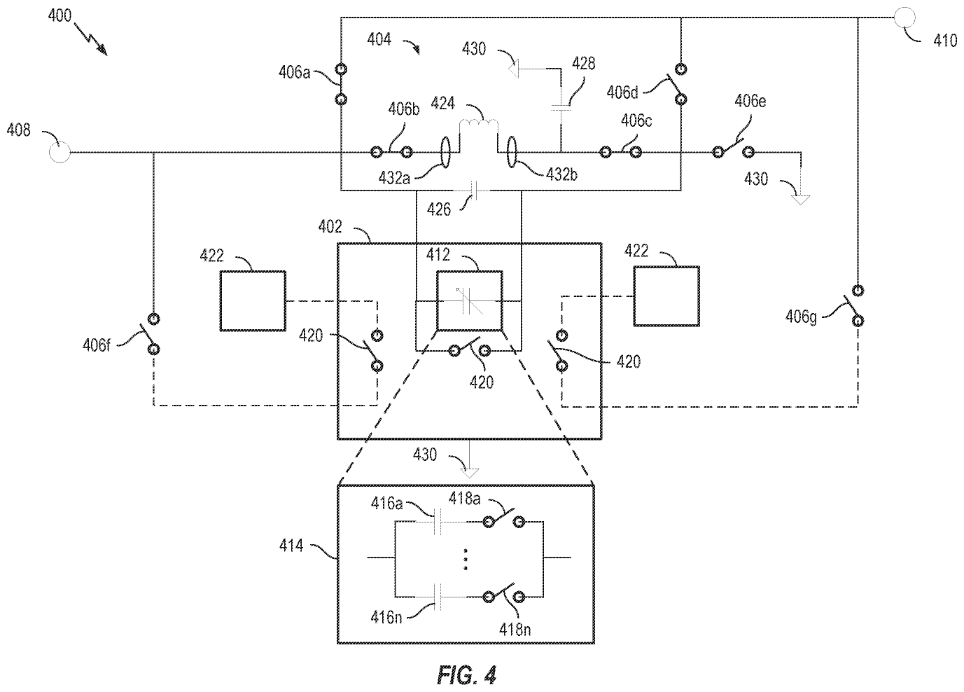

Aspects described herein overcome the aforementioned technical problem(s) by providing jammer rejection at an antenna tuner of an RF receiver. An antenna tuner includes a variable capacitor, for example, as a capacitor bank as further described herein with respect to FIG. 4. The variable capacitor may be used to perform tunable impedance matching between an antenna and receive path circuitry. Jammer rejection circuitry at the antenna tuner may be implemented using the variable capacitor and a reactive component, such as an inductor. For example, an inductor-capacitor (LC) filter may be formed using the variable capacitor and the inductor. In some cases, the jammer rejection circuitry may form a low pass filter configured to suppress or reject a harmonic frequency of a local oscillator, such as the third harmonic (3FLO) described above. In certain aspects, the jammer rejection circuitry may be selectively applied or bypassed via switches. For example, a set of switches may be used to bypass the jammer rejection circuitry, for example, when a jammer signal is not detected or encountered on the receive path. The set of switches may be used to apply the jammer rejection circuitry, for example, when a jammer signal is detected or encountered on the receive path.

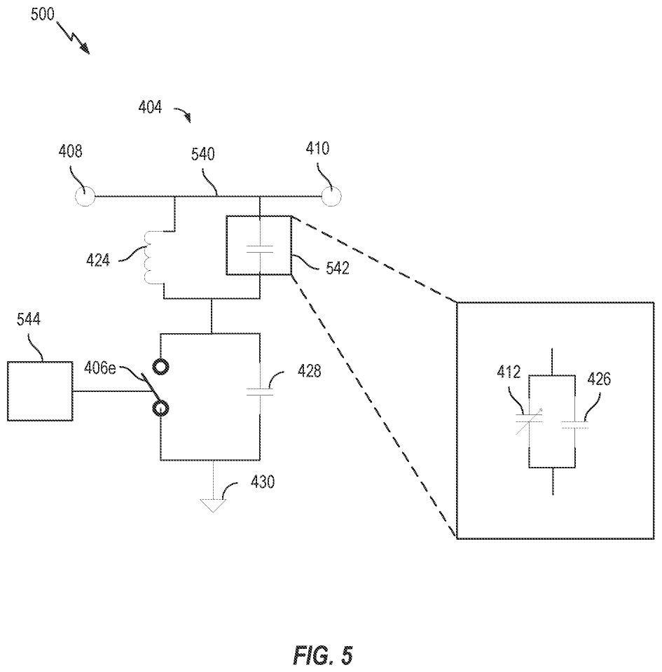

The jammer rejection at an antenna tuner described herein may provide various beneficial effects and/or advantages. The jammer rejection at an antenna tuner may enable relaxed specifications (e.g., lower quality factor or fewer pass bands) for jammer rejection implemented in other front end filters (e.g., in the form of an acoustic wave resonator or filter) as described above, and such relaxed specifications may enable a reduction in complexity and/or cost of said jammer rejection. The relaxed specifications at the RF filter and/or low noise amplifier may be attributable to multi-stage jammer rejection being implemented at the antenna tuner and low noise amplifier. For example, the jammer rejection at the antenna tuner may supplement the jammer rejection in a RF filter or at the low noise amplifier. In some cases, the jammer rejection at the antenna tuner may be implemented with minimal circuit modifications, such as an inductor and switching, as further described herein with respect to FIG. 5.

As used herein, jammer rejection may involve rejection or suppression of a jammer signal and/or a harmonic of the jammer signal.

### Example Wireless Communications System

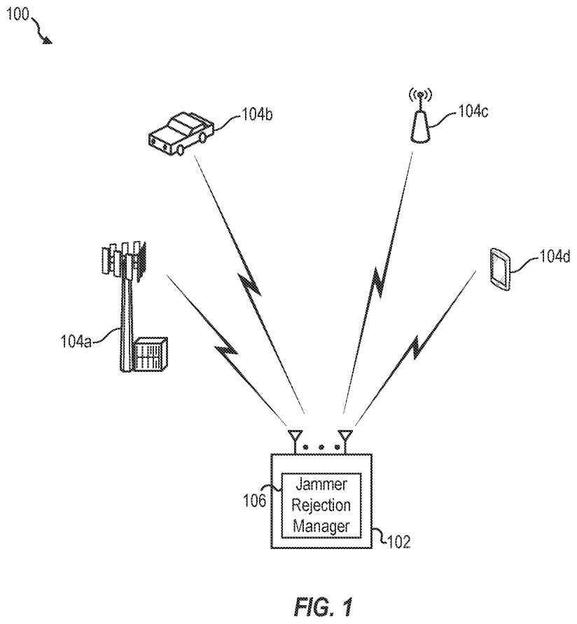

FIG. 1 illustrates an example wireless communications system 100 in which aspects of the present disclosure may be performed. For example, the wireless communications system 100 may include a wireless wide area network (WWAN) and/or a wireless local area network (WLAN). For example, a WWAN may include a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation (2G) or Third Generation (3G) network), a code division multiple access (CDMA) system (e.g., a 2G/3G network), any future WWAN system, or any combination thereof. A WLAN may include a wireless network configured for communications according to an Institute of Electrical and Electronics Engineers (IEEE) standard such as one or more of the 802.11 standards, etc. In some cases, the wireless communications system 100 may include a device-to-device (D2D) communications network or a short-range communications system, such as Bluetooth communications.

As illustrated in FIG. 1, the wireless communications system 100 may include a first wireless device 102 communicating with any of various second wireless devices 104a-d (hereinafter “the second wireless device 104”) via any of various radio access technologies (RATs), where a wireless device may refer to a wireless communications device. The RATs may include, for example, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), etc.

The first wireless device 102 may include any of various wireless communications devices including a user equipment (UE), a wireless station, an access point, customer-premises equipment (CPE), etc. In certain aspects, the first wireless device 102 includes a jammer rejection manager 106 that applies jammer rejection at an antenna tuner, in accordance with aspects of the present disclosure.

The second wireless device 104 may include, for example, a base station 104a, a vehicle 104b, an access point (AP) 104c, and/or a UE 104d. Further, the wireless communications systems 100 may include terrestrial aspects, such as ground-based network entities (e.g., the base station 104a and/or access point 104c), and/or non-terrestrial aspects, such as a spaceborne platform and/or an aerial platform, which may include network entities on-board (e.g., one or more base stations) capable of communicating with other network elements (e.g., terrestrial base stations) and/or user equipment.

The base station 104a may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The first wireless device 102 and/or the UE 104d may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. A UE may also be referred to more generally as a mobile device, a wireless device, a wireless communications device, a wireless station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

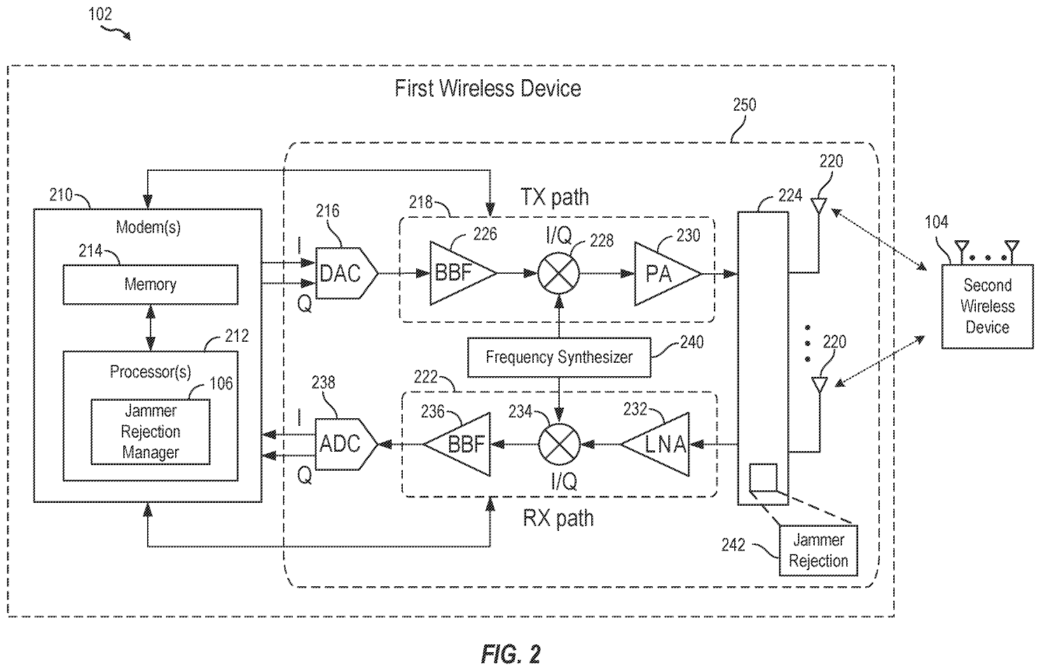

FIG. 2 illustrates example components of the first wireless device 102, which may be used to communicate with any of the second wireless devices 104.

The first wireless device 102 may be, or may include, a chip, system on chip (SoC), system in package (SiP), chipset, package, device that includes one or more modems 210 (hereinafter “the modem 210”). In some cases, the modem 210 may include, for example, any of a WWAN modem (e.g., a modem configured to communicate via E-UTRA 5G NR, and/or any future WWAN communications standards), a WLAN modem (e.g., a modem configured to communicate via IEEE 802.11 standards), a Bluetooth modem, a NTN modem, etc. In certain aspects, the first wireless device 102 also includes one or more RF transceivers (hereinafter “the RF transceiver 250”). In some cases, the RF transceiver 250 may be referred to as an RF front end (RFFE). In some aspects, the modem 210 further includes one or more processors, processing blocks or processing elements (hereinafter “the processor 212”) and one or more memory blocks or elements (hereinafter “the memory 214”). The processor 212 may include the jammer rejection manager 106 configured to suppress a jammer signal and/or a harmonic thereof in accordance with aspects of the present disclosure. In some cases a portion or all of the jammer rejection manager 106 may be included within the transceiver 250.

In certain aspects, the processor 212 may process any of certain protocol stack layers associated with a radio access technology (RAT). For example, the processor 212 may process any of an application layer, packet layer, WLAN protocol stack layers (e.g., a link or a medium access control (MAC) layer), and/or WWAN protocol stack layers (e.g., a radio resource control (RRC) layer, a packet data convergence protocol (PDCP) layer, a radio link control (RLC) layer, and a MAC layer).

The modem 210 may generally be configured to implement a physical (PHY) layer. For example, the modem 210 may be configured to modulate packets and to output the modulated packets to the RF transceiver 250 for transmission over a wireless medium. The modem 210 is similarly configured to obtain modulated packets received by the RF transceiver 250 and to demodulate the packets to provide demodulated packets. In addition to a modulator and a demodulator, the modem 210 may further include digital signal processing (DSP) circuitry, automatic gain control (AGC), a coder, a decoder, a multiplexer, and/or a demultiplexer (not shown).

As an example, while in a transmission mode, the modem 210 may obtain data from a data source, such as an application processor. The data may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 216. In certain aspects involving beamforming, the modulated symbols in the respective spatial streams may be precoded via a steering matrix prior to provision to the IFFT block.

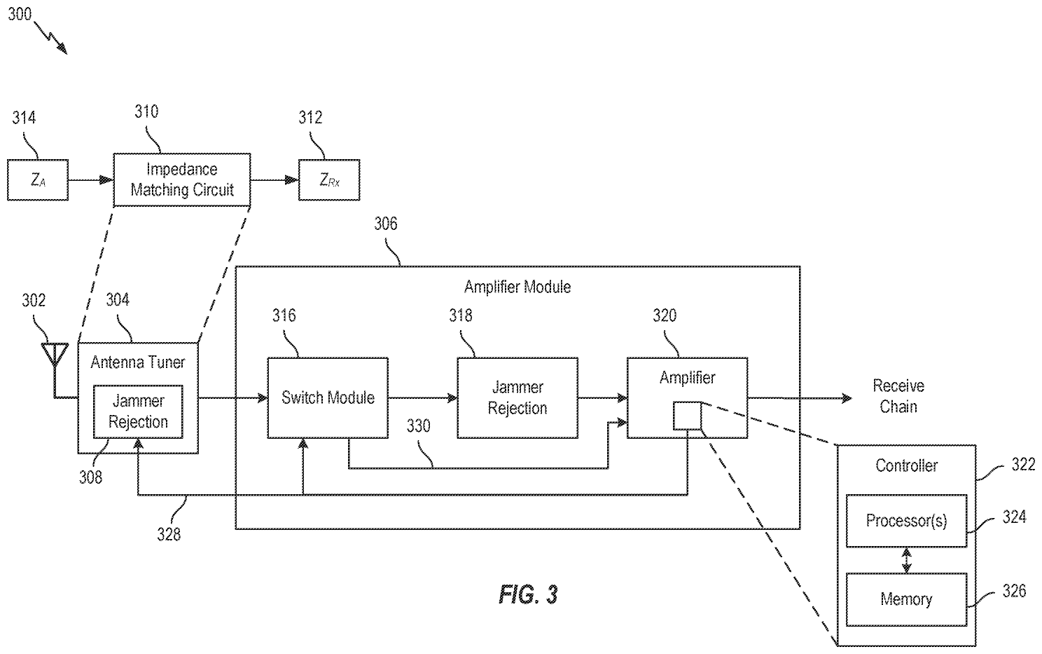

The modem 210 may be coupled to the RF transceiver 250 including a transmit (TX) path 218 (also known as a transmit chain) for transmitting signals via one or more antennas 220 (hereinafter “the antenna 220”) and a receive (RX) path 222 (also known as a receive chain) for receiving signals via the antennas 220. When the TX path 218 and the RX path 222 share an antenna 220, the paths may be coupled to the antenna 220 via an interface 224, which may include any of various suitable RF devices, such as an antenna tuner, a switch, a duplexer, a diplexer, a multiplexer, and the like. In certain aspects, the interface 224 may include jammer rejection circuitry 242 as further described herein with respect to FIGS. 3 and 4. As an example, the modem 210 may output digital in-phase (I) and/or quadrature (Q) baseband signals representative of the respective symbols to the DAC 216.

Receiving I or Q baseband analog signals from the DAC 216, the TX path 218 may include a baseband filter (BBF) 226, a mixer 228 (which may include one or several mixers), and a power amplifier (PA) 230. The BBF 226 filters the baseband signals received from the DAC 216, and the mixer 227 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 228 are typically RF signals, which may be amplified by the PA 230 before transmission by the antenna 220. The antennas 220 may emit RF signals, which may be received at the second wireless device 104. While one mixer 228 is illustrated, several mixers may be used to upconvert the filtered baseband signals to one or more intermediate frequencies and to thereafter upconvert the intermediate frequency signals to a frequency for transmission.

The RX path 222 may include a low noise amplifier (LNA) 232, a mixer 234 (which may include one or several mixers), and a baseband filter (BBF) 236. RF signals received via the antenna 220 (e.g., from the second wireless device 104) may be amplified by the LNA 232, and the mixer 234 mixes the amplified RF signals with a receive local oscillator (LO) signal to convert the RF signal to a baseband frequency (e.g., downconvert). The baseband signals output by the mixer 234 may be filtered by the BBF 236 before being converted by an analog-to-digital converter (ADC) 238 to digital I or Q signals for digital signal processing. The modem 210 may receive the digital I or Q signals and further process the digital signals, for example, demodulating the digital signals into information.

Certain transceivers may employ frequency synthesizers with a voltage-controlled oscillator (VCO) to generate a stable, tunable LO frequency with a particular tuning range. Thus, the transmit LO frequency may be produced by a frequency synthesizer 240, which may be buffered or amplified by an amplifier (not shown) before being mixed with the baseband signals in the mixer 228. Similarly, the receive LO frequency may be produced by the frequency synthesizer 240, which may be buffered or amplified by an amplifier (not shown) before being mixed with the RF signals in the mixer 234. Separate frequency synthesizers may be used for the TX path 218 and the RX path 222.

While in a reception mode, the modem 210 may obtain digitally converted signals via the ADC 238 and RX path 222. As an example, in the modem 210, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 212) for processing, evaluation, or interpretation.

The modem 210 and/or processor 212 may control the transmission of signals via the TX path 218 and/or reception of signals via the RX path 222. In some aspects, the modem 210 and/or processor 212 may be configured to perform various operations, such as those associated with any of the methods described herein. The modem 210 and/or processor 212 may include a microcontroller, a microprocessor, an application processor, a baseband processor, a MAC processor, an artificial intelligence processor, a digital signal processor (DSP), an application specific integrated circuit (ASIC), a field programmable gate array (FPGA) or other programmable logic device (PLD), discrete gate or transistor logic, discrete hardware components, or any combination thereof. The memory 214 may store data and program codes (e.g., processor-readable instructions) for performing wireless communications as described herein. In some cases, the memory 214 may be external to the modem 210 and/or processor 212 and/or incorporated therein (as illustrated).

FIG. 2 shows an example transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

### Example Antenna Tuner with Jammer Rejection

Aspects of the present disclosure provide techniques for jammer rejection at an antenna tuner. In certain aspects, the jammer rejection may be performed using some of the impedance matching circuitry of an antenna tuner. The jammer rejection described herein may enable multi-stage jammer rejection, for example, implemented at an antenna tuner and amplifier in a receive chain. Such multi-stage jammer rejection can enable a relaxation in filtering specifications for the jammer rejection implemented at the amplifier, which can translate into improved performance of the jammer rejection (e.g., enhanced received signal quality) and/or reduced cost for some filter components (e.g., acoustic wave filters used for the jammer signal rejection).

FIG. 3 illustrates an example RF receive chain circuit 300 with jammer rejection available at an antenna tuner. In this example, the RF receive chain circuit 300 may be an example of a receive chain or certain aspects thereof, such as the receive path 222 of the RF transceiver 250 shown in FIG. 2. In some cases, the RF receive chain circuit 300 may be representative of a diversity receive path of an RF transceiver 250. In certain aspects, the RF receive chain circuit 300 may be included in or integrated with an RF front end circuit or package. The RF receive chain circuit 300 may include one or more antennas 302 (hereinafter “the antenna 302”), an antenna tuner 304, and an amplifier module 306. In certain aspects, the RF receive chain circuit 300 may include multiple stages of jammer rejection including, for example, a first stage of jammer rejection applied at the antenna tuner 304 and a second stage of jammer rejection applied at the amplifier module 306. The antenna 302 may be an example of the antenna 220 of FIG. 2.

The antenna tuner 304 is coupled between the antenna 302 and the amplifier module 306. The antenna tuner 304 includes a first jammer rejection circuit 308 and an impedance matching circuit 310 as further described herein with respect to FIG. 4. In certain aspects, the RF receive chain circuit 300 may include a circuit package comprising the antenna tuner 304 and the first jammer rejection circuit 308. The antenna tuner 304 may be representative of a circuit package including the first jammer rejection circuit 308 and the impedance matching circuit 310. The circuit package may be or include an integrated circuit (IC) package and/or one or more electrical components coupled to a circuit board. In certain aspects, the antenna tuner 304 may be an example of the interface 224 of FIG. 2 or a feature thereof. The first jammer rejection circuit 308 may be formed via at least one reactive component and the impedance matching circuit 310 as further described herein. In certain aspects, the first jammer rejection circuit 308 may be configured as a low pass filter that is capable of filtering out an upper harmonic of a jammer signal, such as a third harmonic (3FLO) as discussed above. The third harmonic may be outside a passband of the first jammer rejection circuit 308. The first jammer rejection circuit 308 may enable distributed jammer rejection or multi-stage jammer rejection at the antenna tuner 304 and the amplifier module 306. The first jammer rejection may enable a reduction in jammer rejection specifications implemented at the amplifier module 306, which can enable improved overall jammer rejection and/or reduced costs of the jammer rejection implemented at the amplifier module 306.

The impedance matching circuit 310 may be configured to adjust its impedance to balance the impedances of the antenna 302 and the receive chain circuitry coupled to the antenna tuner 304. In certain aspects, the impedance matching circuit 310 may be configured to increase power transfer and/or reduce power being reflected between the antenna 302 and the receive chain circuitry. In some cases, the impedance matching circuit 310 may be configured to effectively match a receive chain impedance 312 (Z_{Rx}) and an antenna impedance 314 (Z_{A}) of the antenna 302 coupled to the antenna tuner 304. The receive chain impedance 312 is the impedance of the receive chain circuitry (e.g., the cascade of circuitry including the amplifier module) coupled to the antenna tuner 304. The impedance of the impedance matching circuit 310 depends on the receive chain impedance 312 and the antenna impedance 314, each of which may vary due to the received signal power and/or carrier frequency. For example, multiple antennas 302 may be coupled to the antenna tuner 304, and at least some of the antennas 302 may be frequency dependent and have different antenna impedances 314.

The amplifier module 306 is coupled to an output of the antenna tuner 304, such that the antenna tuner 304 feeds a signal received via the antenna 302 to the amplifier module 306. The amplifier module 306 may include a switch module 316, a second jammer rejection circuit 318, and an amplifier 320. In certain aspects, the amplifier module 306 may be or include an integrated circuit and/or circuit package.

The switch module 316 may include a set of switches configured to switch between a first mode (e.g., a bypass mode) and a second mode (e.g., a jammer rejection mode) as further discussed below. In certain aspects, the switch module 316 may be coupled to multiple antenna tuners (not shown) to enable selective coupling between the antenna tuners and the amplifier 320. The amplifier module 306 may amplify a signal received via the antenna 302 using the amplifier 320.

In certain aspects, the amplifier 320 may be or include a low noise amplifier, such as the LNA 232 of FIG. 2. Note that the switch module 316 and/or the second jammer rejection circuit 318 may be integrated with the amplifier module 306. In some cases, the switch module 316 and/or the second jammer rejection circuit 318 may be coupled to amplifier module 306 as separate circuitry.

The amplifier 320 may have an input selectively coupled to an output of the antenna tuner 304, for example, via the switch module 316. The second jammer rejection circuit 318 may be (selectively) coupled to the amplifier 320 and/or selectively bypassed. In certain aspects, the second jammer rejection circuit 318 may be or include a filter or a filter bank. The second jammer rejection circuit 318 may be or include a bandpass filter configured to suppress a jammer signal, which may be outside the passband of the bandpass filter. In certain aspects, the second jammer rejection circuit 318 may be or include a surface acoustic wave (SAW) resonator and/or a bulk acoustic wave (BAW) resonator.

In certain aspects, the amplifier 320 may be configured to control when to activate and/or deactivate the first jammer rejection circuit 308 and/or the second jammer rejection circuit 318 in response to jammer signal detection. For example, the amplifier 320 may include a controller 322 that is capable of detecting a jammer signal (and/or a harmonic thereof) in the received signal. The controller 322 may be an example of a jammer signal detector. Note that any suitable jammer detection circuitry may be used in addition to or instead of the controller 322. The controller 322 may be coupled to the first jammer rejection circuit 308 and/or the switch module 316, for example, via a control interface 328. The controller 322 may output a control signal that indicates whether to activate or deactivate the first jammer rejection circuit 308 and/or the second jammer rejection circuit 318. For example, the control signal may be or include a digital signal having a first state (e.g., a high voltage state) and a second state (e.g., a low voltage state) that control the switching states of one or more switches as further described herein.

In response to a jammer signal (and/or a harmonic thereof) being detected in the received signal, the controller 322 may output, to the first jammer rejection circuit 308 and/or the switch module 316, a first control signal configured to activate or enable the respective jammer rejection circuit(s). The first control signal may toggle a set of switches in the antenna tuner 304 into a jammer rejection mode, where the set of switches feeds the received signal to the first jammer rejection circuit 308 and the impedance matching circuit 310 as further described herein with respect to FIG. 4. The first control signal may toggle the switch module 316 into a jammer rejection mode, where the switch module 316 feeds the received signal to the second jammer rejection circuit 318, which then outputs a filtered signal to the amplifier 320.

In response to a jammer signal (and/or a harmonic thereof) not being detected in the received signal, the controller 322 may output, to the first jammer rejection circuit 308 and/or the switch module 316, a second control signal configured to deactivate or bypass the respective jammer rejection circuit(s). The second control signal may toggle a set of switches in the antenna tuner 304 into a bypass mode, where the set of switches bypasses the first jammer rejection circuit 308 and feeds the received signal to the impedance matching circuit 310 as further described herein with respect to FIG. 4. The second control signal may toggle the switch module 316 into a bypass mode, where the switch module 316 feeds the received signal to the amplifier 320 and bypasses the second jammer rejection circuit 318 via a bypass interface 330.

The controller 322 may be or include one or more processors 324 (hereinafter “the processor 324”) coupled to one or more memories (hereinafter “the memory 326”). The processor 324 may be or include a microcontroller, a microprocessor, an artificial intelligence processor, a digital signal processor (DSP), an application specific integrated circuit (ASIC), a field programmable gate array (FPGA) or other programmable logic device (PLD), discrete gate or transistor logic, discrete hardware components, a finite state machine, or any combination thereof designed to perform the functions described herein. The memory 326 may store processor-executable instructions that when executed by the processor 324 cause the processor 324 to perform any of the functions described herein. The processor 324 and the memory 326 may be an example of the processor 212 and the memory 214 of FIG. 2, respectively.

FIG. 4 illustrates an example antenna tuner 400 with selective jammer rejection. The antenna tuner 400 may be an example of the antenna tuner 304 of FIG. 3. The antenna tuner 400 comprises an impedance matching circuit 402, a first filter 404, and a first set of switches 406a-g. The antenna tuner 400 is coupled between a first node 408 and a second node 410, which may be representative of an input port and an output port, respectively. For example, the first node 408 may be coupled to an antenna (not shown), such as the antenna 302 of FIG. 3; and the second node 410 may be coupled to an amplifier (not shown), such as the amplifier 320 of FIG. 3.

The impedance matching circuit 402 may be or include a tunable impedance circuit including, for example, a tunable capacitor 412. In some cases, the tunable capacitor 412 may be or include a capacitor bank 414 having a plurality of capacitors 416a-n arranged in parallel with each other, where each of the capacitors 416a-n is coupled in series with a switch 418a-n. The tunable capacitor 412 may have a range of capacitances available for selection, for example, from 0.1 to 10 picofarads (pF). The impedance matching circuit 402 may be an example of the impedance matching circuit 310 of FIG. 3. In certain aspects, the impedance matching circuit 402 may include one or more auxiliary switches 420 that enable selective coupling to one or more auxiliary loads for impedance matching and/or bypassing the tunable capacitor 412. In some cases, the switch 406f may be coupled between the first node 408 and at least one of the auxiliary switches 420. Likewise, the switch 406g may be coupled between the second node 410 and at least one of the auxiliary switches 420.

The first filter 404 may be formed via the tunable capacitor 412 and at least one reactive component including, for example, a first inductive component 424 and/or a first capacitive component 426. The first filter 404 may be an example of the first jammer rejection circuit 308 of FIG. 3. The first filter 404 may be or include a low pass filter, such as a second order low pass filter. The first filter 404 may be configured to suppress at least one harmonic frequency associated with a local oscillator frequency (e.g., a jammer signal). An example harmonic may include the third harmonic as described herein, and the third harmonic may be outside of the passband of the first filter 404. The tunable capacitor 412 may enable the first filter 404 to have a tunable narrow passband response, for example, from 1 GHz to 2.7 GHZ. For example, the at least one reactive component may be coupled in parallel with the tunable capacitor 412. The first inductive component 424 may be coupled in parallel with the first capacitive component 426.

In certain aspects, the first inductive component 424 may be or include an inductor; and the first capacitive component 426 may be or include a capacitor. In certain cases, the first capacitive component 426 is integrated with or external to the tunable capacitor 412 as illustrated in FIG. 4. The capacitance of the first capacitive component 426 may be selected to complement or supplement the tunable range of the tunable capacitor 412. As an example, the capacitance of the first capacitive component 426 may be selected to be the smallest, intermediate, or largest available capacitance of the combined capacitor formed from the first capacitive component 426 and the tunable capacitor 412. In some cases, the at least one reactive component may further include a second capacitive component 428 coupled to a reference potential node 430, as further described below.

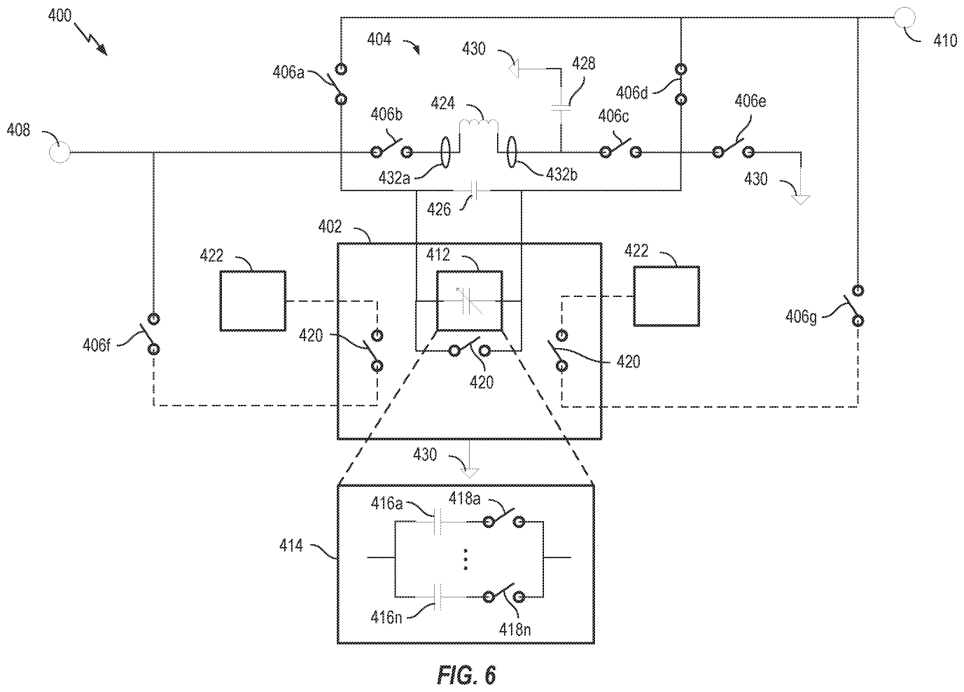

The first set of switches 406a-g may be coupled to at least the first filter 404. The first set of switches 406a-g may be configured to switch among at least a first mode (e.g., a bypass mode) and a second mode (e.g., a jammer rejection mode). The first mode is configured to bypass the filter across a signal path, which may be an electrical signal path between the first node 408 and the second node 410, the first mode being depicted in FIG. 6. The second model is configured to apply the first filter 404 across the signal path as illustrated in FIG. 4.

The first set of switches 406a-g include a first switch 406a coupled between the first node 408 and the second node 410. The first set of switches 406a-g further include a second switch 406b coupled between the first node 408 and a first terminal 432a of the first inductive component 424. The first set of switches 406a-g also include a third switch 406c coupled between a second terminal 432b of the first inductive component 424 and a fourth switch 406d. The first set of switches 406a-g includes the fourth switch 406d coupled to at least the second node 410, and as illustrated, between the second node 410 and the third switch 406c.

In the second mode (e.g., a jammer rejection mode), the first switch 406a, second switch 406b, and third switch 406c are closed; and the fourth switch 406d is open. In the second mode, the first filter 404 is coupled to the signal path between the first node 408 and the second node 410 as further described herein with respect to FIG. 5. In some cases, the control interface 328 of FIG. 3 may be coupled to the first set of switches 406a-g to control which switches are open and/or closed for a particular mode (e.g., the first mode and second mode). As an example, the controller 322 may output a first control signal configured to open the first switch 406a, second switch 406b, and third switch 406c and close the fourth switch 406d in response to detecting a jammer signal and/or a harmonic thereof in a received signal. The controller 322 may be configured to output, in response to detecting a jammer signal (and/or a harmonic thereof), a control signal configured to trigger the first set of switches first set of switches 406a-g and a second set of switches (e.g., the switch module 316) to switch from the first mode to the second mode. The controller 322 may output a second control signal configured to open the first switch 406a, second switch 406b, and third switch 406c and close the fourth switch 406d in response to detecting a received signal without a jammer signal and/or a harmonic thereof.

In some cases, the second mode may use a fifth switch 406e coupled between the third switch 406c and the reference potential node 430, as further described herein with respect to FIG. 5. The fifth switch 406e may be used to selectively bypass or apply the second capacitive component 428 in the first filter 404, for example, depending on the frequency of the jammer signal and/or a harmonic thereof. The second capacitive component 428 may be coupled between the second terminal 432 of the first inductive component 424 and the reference potential node 430.

In certain aspects, the first mode and the second mode as discussed above may be applied in conjunction with the switch module 316 (e.g., representative of a second set of switches) and the second jammer rejection circuit 318 (e.g., representative of a second filter). The switch module 316 may be configured to switch among at least the first mode and the second mode. The first mode further bypasses the second jammer rejection circuit 318 (e.g., a second filter) between the antenna tuner 304 and the amplifier 320, and the second mode further couples the output of the second jammer rejection circuit 318 (e.g., the second filter) to the input of the amplifier 320.

FIG. 5 illustrates an example equivalent circuit 500 of the antenna tuner described with respect to FIG. 4 in a jammer rejection mode. As shown, the first filter 404 is applied across a signal path 540 between the first node 408 and the second node 410. A third capacitor 542 is depicted as the combined capacitance of the tunable capacitor 412 and the first capacitive component 426. The second capacitive component 428 can be selectively applied or bypassed via the fifth switch 406e, for example, depending on the frequency of the jammer signal and/or a harmonic thereof. As an example, for a low-band jammer, the fifth switch 406e may be closed to operate the first filter 404 as a tank circuit. For a jammer signal above the low-band, the fifth switch 406e may be opened to trap higher frequencies via the second capacitive component 428. For example, a first circuit 544 may be configured to output a first control signal configured to close the fifth switch 406e in response to detecting a signal at a frequency less than or equal to a threshold (e.g., a low band frequency of 1 GHz); or output a second control signal configured to open the fifth switch in response to detecting the signal at a frequency greater than the threshold (e.g., the low band frequency). In certain aspects, the first circuit 544 that controls the fifth switch 406e may be or include a processor and memory (e.g., the controller 322) or a bandpass filter coupled to a rectifier to provide frequency dependent controls.

FIG. 6 illustrates the antenna tuner 400 of FIG. 4 configured in bypass mode. As shown, the fourth switch 406d is closed; and the switches 406a-c, e are open, such that the first filter 404 is bypassed along the signal path between the first node 408 and the second node 410. Note that other switching modes and/or switch arrangements may be used in addition to or instead of that depicted in FIGS. 4 and 6.

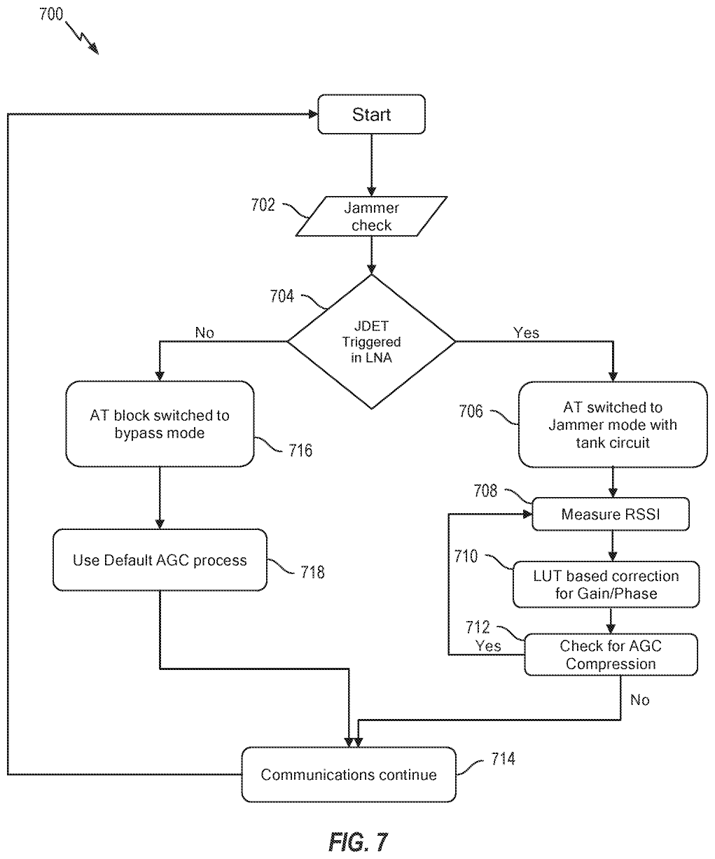

FIG. 7 illustrates example operations 700 for applying or bypassing jammer rejection at an antenna tuner, for example, as shown in FIGS. 3, 4, and 6. The operations 700 may be performed by an RF receiver (e.g., the RF receive chain circuit 300 of FIG. 3) and/or an RF transceiver (e.g., the RF transceiver 250 of FIG. 2). In certain aspects, the operations 700 may be performed by a controller (e.g., the controller 322 of FIG. 3).

The operations may optionally begin at block 702, where the RF receiver checks for a jammer signal and/or a harmonic thereof in a received signal. The RF receiver may periodically monitor a received signal in the receive chain, for example, at an LNA (e.g., the amplifier 320). The RF receiver may obtain a sample of the received signal and determine whether a jammer signal and/or a harmonic thereof (e.g., 3FLO) is in the received signal.

At block 704, the RF receiver may determine whether jammer detection (JDET) is triggered, for example, at the LNA, based on the sample of the received signal. For example, jammer detection may be triggered if a jammer signal and/or a harmonic thereof is identified in the sample of the received signal.

At block 706, if jammer detection is triggered, an antenna tuner (e.g., the antenna tuner 304) is switched to (or operated in) jammer rejection mode, for example, with a jammer rejection circuit (e.g., the first jammer rejection circuit 308 or the first filter 404) being activated at the antenna tuner.

At block 708, the RF receiver may measure a signal strength of the received signal (e.g., received signal strength indicator (RSSI)).

At block 710, the RF receiver may perform automatic gain control (AGC) operations in order to provide a stable output signal at the LNA. For example, the RF receiver may identify certain operating parameters of the LNA based on the signal strength measurement (e.g., RSSI) to provide certain phase/gain corrections and/or automatic gain controls. The operating parameters may be specific to operating in jammer rejection mode at the antenna tuner. In some cases, the operating parameters may be selected from a look-up table (LUT). The operating parameters may include a control voltage or current for the gain

At block 712, the RF receiver may check if there is AGC compression at the output signal of the LNA. If there is AGC compression, the RF receiver may re-evaluate the signal strength and corresponding operating parameters.

At block 714, the RF receiver may continue to process the received signal in the receive chain, for example, as described herein with respect to FIG. 2.

At block 716, if jammer detection is not triggered, the antenna tuner is switched to (operated in) bypass mode, for example, where the jammer rejection circuit is bypassed as depicted in FIG. 6.

At block 718, the RF receiver may perform the default AGC process using operating parameters for the LNA that are specific to operating bypass mode at the antenna tuner.

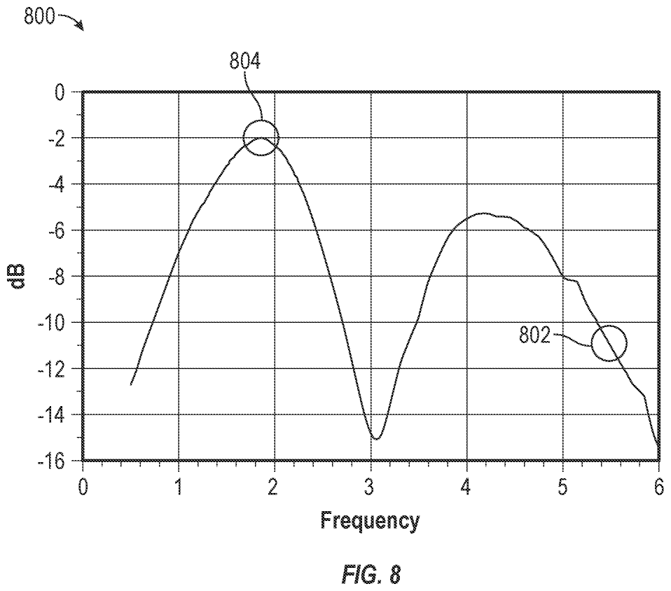

FIG. 8 illustrates an example frequency response 800 of the forward voltage gain (S₂₁) observed at an antenna tuner with jammer rejection enabled. In this example, the jammer rejection circuit is configured to suppress a third harmonic (e.g., 5.5 GHZ) of a local oscillator frequency (e.g., 1.850 GHz). As shown, a third harmonic 802 is suppressed to about −11 dB, whereas a jammer signal frequency 804 is at about −2 dB. Such suppression on the third harmonic by the jammer rejection circuit at the antenna tuner can enable a relaxation of filter specifications at a second stage of jammer rejection (e.g., the second jammer rejection circuit 318).

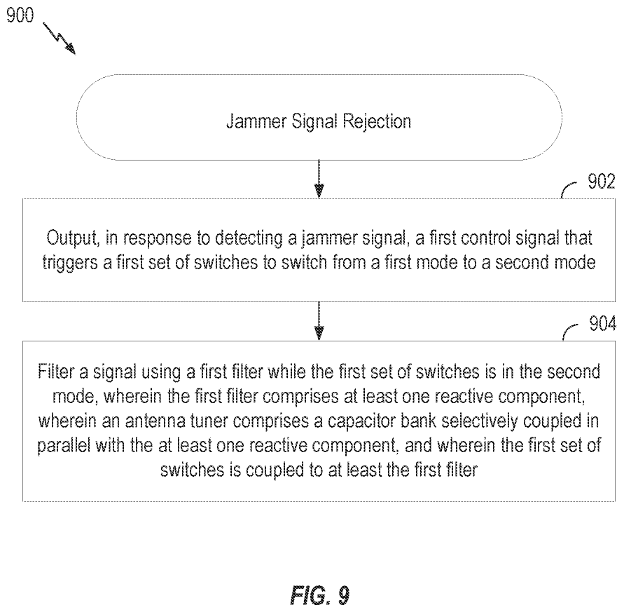

FIG. 9 illustrates example operations 900 for suppressing a jammer signal in an RF receive chain circuit. The operations 900 may be performed, for example, by a wireless device (e.g., the first wireless device 102 in the wireless communications system 100). In certain aspects, the operations 900 may be performed by an RF receiver (e.g., the RF receive chain circuit 300 of FIG. 3) and/or an RF transceiver (e.g., the RF transceiver 250 of FIG. 2). In certain aspects, the operations 900 may be performed by a controller (e.g., the controller 322 of FIG. 3). The operations 900 may be implemented as software components that are executed and run on one or more processors (e.g., the modem 210 and/or the processor 212 of FIG. 2). Further, the transmission and/or reception of signals by the wireless device in the operations 900 may be enabled, for example, by one or more antennas (e.g., the antenna 220 of FIG. 2). In certain aspects, the transmission and/or reception of signals by the wireless device may be implemented via a bus interface of one or more processors (e.g., the modem 210 and/or the processor 212) obtaining and/or outputting signals for reception or transmission.

The operations 900 may optionally begin, at block 902, where the wireless device outputs, in response to detecting a jammer signal and/or a harmonic thereof, a first control signal that triggers a first set of switches (e.g., the first set of switches 406a-g) to switch from a first mode (e.g., a bypass mode) to a second mode (e.g., a jammer rejection mode), for example, as described herein with respect to FIGS. 3-6.

At block 904, the wireless device filters a signal using a first filter (e.g., the first filter 404) while the first set of switches is in the second mode. In certain aspects, the first filter comprises at least one reactive component. In certain aspects, the at least one reactive component comprises a first inductive component (e.g., the first inductive component 424) and a first capacitive component (e.g., the first capacitive component 426), and the first inductive component is coupled in parallel with the first capacitive component. An antenna tuner (e.g., the antenna tuner 400) comprises a capacitor bank (e.g., the tunable capacitor 412) selectively coupled in parallel with the at least one reactive component. The first set of switches is coupled to at least the first filter. To filter the signal, the wireless device may suppress at least one harmonic frequency (3FLO) associated with a local oscillator frequency.

In certain aspects, the first set of switches comprises a first switch (e.g., the first switch 406a) coupled between a first node (e.g., the first node 408) and a second node (e.g., the second node 410); a second switch (e.g., the fourth switch 406d) coupled to at least the second node; a third switch (e.g., the second switch 406b) coupled between the first node and a first terminal (e.g., the first terminal 432a) of the first inductive component; and a fourth switch (e.g., the third switch 406c) coupled between a second terminal (e.g., the second terminal 432b) of the first inductive component and the second switch, the second switch being coupled between the second node and the fourth switch.

In certain aspects, to output the first control signal, the wireless device may output the first control signal that is configured to close the first switch, the third switch, and the fourth switch and open the second switch in response to detecting the jammer signal in a received signal.

In certain aspects, the wireless device may output, in response to detecting a received signal without any jammer signal, a second control signal that triggers the first set of switches to switch from the second mode to the first mode, the second control signal being configured to open the first switch, the third switch, and the fourth switch and close the second switch. The first wireless device may bypass the first filter while the first set of switches is in the first mode.

In certain aspects, the first set of switches comprises: a fifth switch (e.g., the fifth switch 406e) coupled between the fourth switch and a reference potential node, wherein the at least one reactive component further comprises a second capacitive component (e.g., the second capacitive component 428) coupled between the second terminal of the first inductive component and the reference potential node. In certain aspects, the wireless device may output a second control signal that is configured to close the fifth switch in response to detecting a received signal at a frequency less than or equal to a threshold. In certain aspects, the wireless device may output a third control signal that is configured to open the fifth switch in response to detecting the received signal at a frequency greater than the threshold.

### Example Communications Device

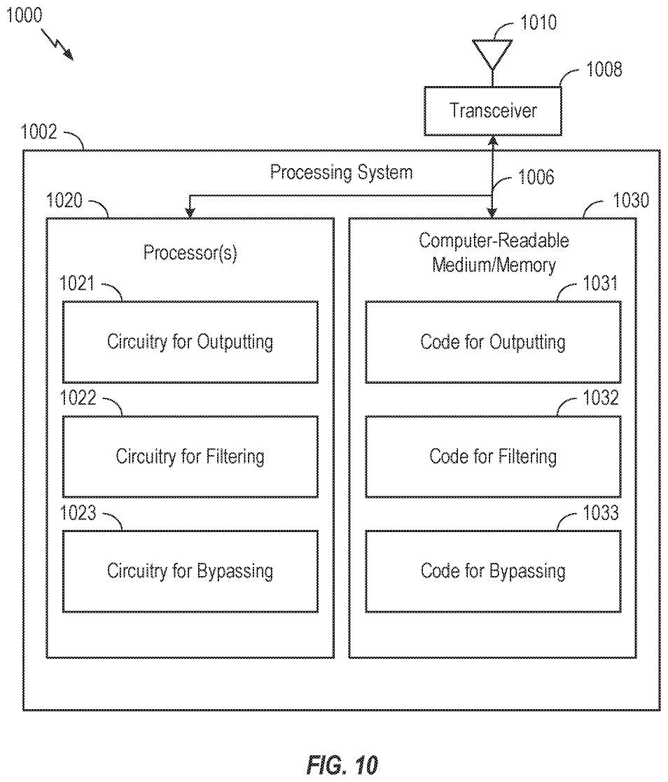

FIG. 10 depicts aspects of an example communications device 1000. In some aspects, communications device 1000 is a wireless communication device, such as the first wireless device 102 described above with respect to FIGS. 1 and 2.

The communications device 1000 includes a processing system 1002 coupled to a transceiver 1008 (e.g., a transmitter and/or a receiver). The transceiver 1008 is configured to transmit and receive signals for the communications device 1000 via an antenna 1010, such as the various signals described herein. The processing system 1002 may be configured to perform processing functions for the communications device 1000, including processing signals received and/or to be transmitted by the communications device 1000.

The processing system 1002 includes one or more processors 1020. In various aspects, the one or more processors 1020 may be representative of any of the modem 210 and/or the processor 212, as described with respect to FIG. 2. The one or more processors 1020 are coupled to a computer-readable medium/memory 1030 via a bus 1006. In certain aspects, the computer-readable medium/memory 1030 is configured to store instructions (e.g., computer-executable code) that when executed by the one or more processors 1020, cause the one or more processors 1020 to perform the operations 900 described with respect to FIG. 9, or any aspect related to the operations described herein. Note that reference to a processor performing a function of communications device 1000 may include one or more processors performing that function of communications device 1000. Reference to one or more processors performing multiple functions may include any one of the one or more processors performing any one of the multiple functions.

In the depicted example, computer-readable medium/memory 1030 stores code (e.g., processor-executable instructions) for outputting 1031, code for filtering 1032, code for bypassing 1033, or any combination thereof. Processing of the code 1031-1033 may cause the communications device 1000 to perform the operations 900 described with respect to FIG. 9, or any aspect related to operations described herein.

The one or more processors 1020 include circuitry configured to implement (e.g., execute) the code stored in the computer-readable medium/memory 1030, including circuitry for outputting 1021, circuitry for filtering 1022, circuitry for bypassing 1023, or any combination thereof. Processing with circuitry 1021-1023 may cause the communications device 1000 to perform the operations 900 described with respect to FIG. 9, or any aspect related to operations described herein.

Various components of the communications device 1000 may provide means for performing the operations 900 described with respect to FIG. 9, or any aspect related to operations described herein. For example, means for transmitting, sending or outputting for transmission may include the TX path 218 and/or antenna 220 of the first wireless device 102 illustrated in FIG. 2 and/or transceiver 108 and antenna 1010 of the communications device 1000 in FIG. 10. Means for receiving or obtaining may include the RX path 222 and/or antenna 220 of the first wireless device illustrated in FIG. 2 and/or transceiver 1008 and antenna 1010 of the communications device 1000 in FIG. 10. In certain aspects, means for outputting a control signal may include one or more processors, such as the modem 210 and/or processor 212 depicted in FIG. 2 and/or the processor(s) 1020 in FIG. 10. In certain aspects, means for filtering may include one or more filters, such as the first jammer rejection circuit 308 of FIG. 3, the second jammer rejection circuit 318 of FIG. 3, and/or the first filter 404 of FIG. 4. In certain aspects, means for bypassing may include a bypass interface, such as the bypass interface 330 of FIG. 3.

### Example Aspects

Implementation examples are described in the following numbered clauses:
Aspect 1: An apparatus, comprising: a first filter comprising at least one reactive component; an antenna tuner comprising a capacitor bank selectively coupled in parallel with the at least one reactive component; and a first set of switches coupled to at least the first filter, wherein the first set of switches is configured to switch among at least a first mode and a second mode, wherein the first mode is configured to bypass the first filter across a signal path, and the second mode is configured to apply the first filter across the signal path.
Aspect 2: The apparatus of Aspect 1, wherein the first filter comprises a low pass filter.
Aspect 3: The apparatus of Aspect 1 or 2, wherein the first filter is configured to suppress at least one harmonic frequency associated with a local oscillator frequency.
Aspect 4: The apparatus according to any of Aspects 1-3, wherein: the at least one reactive component comprises a first inductive component and a first capacitive component; and the first inductive component is coupled in parallel with the first capacitive component.
Aspect 5: The apparatus of Aspect 4, wherein the first set of switches comprises: a first switch coupled between a first node and a second node; a second switch coupled to at least the second node; a third switch coupled between the first node and a first terminal of the first inductive component; and a fourth switch coupled between a second terminal of the first inductive component and the second switch, the second switch being coupled between the second node and the fourth switch.
Aspect 6: The apparatus of Aspect 5, further comprising a first circuit configured to: output a first control signal configured to close the first switch, the third switch, and the fourth switch and open the second switch in response to detecting a jammer signal in a received signal; or output a second control signal configured to open the first switch, the third switch, and the fourth switch and close the second switch in response to detecting the received signal without any jammer signal.
Aspect 7: The apparatus of Aspect 5 or 6, further comprising: a fifth switch coupled between the fourth switch and a reference potential node, wherein the at least one reactive component further comprises a second capacitive component coupled between the second terminal of the first inductive component and the reference potential node.
Aspect 8: The apparatus of Aspect 7, further comprising a first circuit configured to: output a first control signal configured to close the fifth switch in response to detecting a signal at a frequency less than or equal to a threshold; or output a second control signal configured to open the fifth switch in response to detecting the signal at a frequency greater than the threshold.
Aspect 9: The apparatus according to any of Aspects 1-8, further comprising an amplifier circuit comprising: an amplifier having an input selectively coupled to an output of the antenna tuner; a second filter having an output selectively coupled to the amplifier; and a second set of switches coupled to at least the second filter, wherein the second set of switches is configured to switch among at least the first mode and the second mode, wherein the first mode further bypasses the second filter between the antenna tuner and the amplifier, and the second mode further couples the output of the second filter to input of the amplifier.
Aspect 10: The apparatus of Aspect 9, wherein the second filter comprises a bandpass filter configured to suppress a jammer signal.
Aspect 11: The apparatus of Aspect 9 or 10, further comprising one or more processors configured to output, in response to detecting a jammer signal using a jammer signal detector, a control signal configured to trigger the first set of switches and the second set of switches to switch from the first mode to the second mode.
Aspect 12: The apparatus according to any of Aspects 1-11, further comprising a radio frequency (RF) receive chain circuit comprising the first filter, the antenna tuner, and the first set of switches.
Aspect 13: A method of suppressing a jammer signal in a radio frequency (RF) receive chain circuit: outputting, in response to detecting a jammer signal, a first control signal that triggers a first set of switches to switch from a first mode to a second mode; and filtering a signal using a first filter while the first set of switches is in the second mode, wherein the first filter comprises at least one reactive component, wherein an antenna tuner comprises a capacitor bank selectively coupled in parallel with the at least one reactive component, and wherein the first set of switches is coupled to at least the first filter.
Aspect 14: The method of Aspect 13, wherein filtering the signal comprises suppressing at least one harmonic frequency associated with a local oscillator frequency.
Aspect 15: The method of Aspect 13 or 14, wherein: the at least one reactive component comprises a first inductive component and a first capacitive component; and the first inductive component is coupled in parallel with the first capacitive component.
Aspect 16: The method of Aspect 15, wherein the first set of switches comprises: a first switch coupled between a first node and a second node; a second switch coupled to at least the second node; a third switch coupled between the first node and a first terminal of the first inductive component; and a fourth switch coupled between a second terminal of the first inductive component and the second switch, the second switch being coupled between the second node and the fourth switch.
Aspect 17: The method of Aspect 16, wherein outputting the first control signal comprises outputting the first control signal that is configured to close the first switch, the third switch, and the fourth switch and open the second switch in response to detecting the jammer signal in a received signal.
Aspect 18: The method of Aspect 16 or 17, further comprising: outputting, in response to detecting a received signal without any jammer signal, a second control signal that triggers the first set of switches to switch from the second mode to the first mode, the second control signal being configured to open the first switch, the third switch, and the fourth switch and close the second switch; and bypassing the first filter while the first set of switches is in the first mode.
Aspect 19: The method according to any of Aspects 16-18, wherein the first set of switches comprises: a fifth switch coupled between the fourth switch and a reference potential node, wherein the at least one reactive component further comprises a second capacitive component coupled between the second terminal of the first inductive component and the reference potential node.
Aspect 20: The method of Aspect 19, further comprising: outputting a second control signal that is configured to close the fifth switch in response to detecting a received signal at a frequency less than or equal to a threshold; or outputting a third control signal that opens the fifth switch in response to detecting the received signal at a frequency greater than the threshold.
Aspects 21: A radio frequency (RF) chain circuit, comprising: a first filter comprising at least one reactive component; an antenna tuner comprising a capacitor bank selectively coupled in parallel with the at least one reactive component; a first set of switches coupled to at least the first filter, wherein the first set of switches is configured to switch among at least a first mode and a second mode, wherein the first mode is configured to bypass the first filter across a signal path, and the second mode is configured to apply the first filter across the signal path; an amplifier having an input selectively coupled to an output of the antenna tuner; a second filter having an output selectively coupled to the amplifier; and a second set of switches coupled to at least the second filter, wherein the second set of switches is configured to switch among at least the first mode and the second mode, wherein the first mode further bypasses the second filter between the antenna tuner and the amplifier, and the second mode further couples the output of the second filter to input of the amplifier.
Aspect 22: An apparatus, comprising: a memory comprising processor-executable instructions; and one or more processors configured to execute the processor-executable instructions and cause the apparatus to perform a method in accordance with any of Aspects 13-20.
Aspect 23: An apparatus, comprising: a memory; and one or more processors coupled to the memory, the processor being configured to cause the apparatus to perform a method in accordance with any of Aspects 13-20.
Aspect 24: An apparatus, comprising means for performing a method in accordance with any of Aspects 13-20.
Aspect 25: A non-transitory computer-readable medium comprising computer-executable instructions that, when executed by one or more processors of a processing system, cause the processing system to perform a method in accordance with any of Aspects 13-20.
Aspect 26: A computer program product embodied on a computer-readable storage medium comprising code for performing a method in accordance with any of Aspects 13-20.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a microcontroller, a microprocessor, a general-purpose processor, a digital signal processor (DSP), an artificial intelligence processor, an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, identifying, mapping, applying, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” The use of a definite article (e.g., “the” or “said”) before an element is not intended to impart a singular meaning (e.g., “one and only one”) on an otherwise plural meaning (e.g., “one or more”) associated with the element unless specifically so stated. Unless specifically stated otherwise, the term “some” refers to one or more. No claim element is to be construed under the provisions of 35 U.S.C. § 112 (f) unless the element is expressly recited using the phrase “means for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus, comprising:
a first filter comprising at least one reactive component;
an antenna tuner comprising a capacitor bank selectively coupled in parallel with the at least one reactive component; and
a first set of switches coupled to at least the first filter, wherein the first set of switches is configured to switch among at least a first mode and a second mode, wherein the first mode is configured to bypass the first filter across a signal path, and the second mode is configured to apply the first filter across the signal path.

2. The apparatus of claim 1, wherein the first filter comprises a low pass filter.

3. The apparatus of claim 1, wherein the first filter is configured to suppress at least one harmonic frequency associated with a local oscillator frequency.

4. The apparatus of claim 1, wherein:
the at least one reactive component comprises a first inductive component and a first capacitive component; and
the first inductive component is coupled in parallel with the first capacitive component.

5. The apparatus of claim 4, wherein the first set of switches comprises:
a first switch coupled between a first node and a second node;
a second switch coupled to at least the second node;
a third switch coupled between the first node and a first terminal of the first inductive component; and
a fourth switch coupled between a second terminal of the first inductive component and the second switch, the second switch being coupled between the second node and the fourth switch.

6. The apparatus of claim 5, further comprising a first circuit configured to:
output a first control signal configured to close the first switch, the third switch, and the fourth switch and open the second switch in response to detecting a jammer signal in a received signal; or
output a second control signal configured to open the first switch, the third switch, and the fourth switch and close the second switch in response to detecting the received signal without any jammer signal.

7. The apparatus of claim 5, further comprising:
a fifth switch coupled between the fourth switch and a reference potential node, wherein the at least one reactive component further comprises a second capacitive component coupled between the second terminal of the first inductive component and the reference potential node.

8. The apparatus of claim 7, further comprising a first circuit configured to:
output a first control signal configured to close the fifth switch in response to detecting a signal at a frequency less than or equal to a threshold; or
output a second control signal configured to open the fifth switch in response to detecting the signal at a frequency greater than the threshold.

9. The apparatus of claim 1, further comprising an amplifier circuit comprising:
an amplifier having an input selectively coupled to an output of the antenna tuner;
a second filter having an output selectively coupled to the amplifier; and
a second set of switches coupled to at least the second filter, wherein the second set of switches is configured to switch among at least the first mode and the second mode, wherein the first mode further bypasses the second filter between the antenna tuner and the amplifier, and the second mode further couples the output of the second filter to input of the amplifier.

10. The apparatus of claim 9, wherein the second filter comprises a bandpass filter configured to suppress a jammer signal.

11. The apparatus of claim 9, further comprising one or more processors configured to output, in response to detecting a jammer signal using a jammer signal detector, a control signal configured to trigger the first set of switches and the second set of switches to switch from the first mode to the second mode.

12. The apparatus of claim 1, further comprising a radio frequency (RF) receive chain circuit comprising the first filter, the antenna tuner, and the first set of switches.

13. A radio frequency (RF) chain circuit, comprising:
a first filter comprising at least one reactive component;
an antenna tuner comprising a capacitor bank selectively coupled in parallel with the at least one reactive component;
a first set of switches coupled to at least the first filter, wherein the first set of switches is configured to switch among at least a first mode and a second mode, wherein the first mode is configured to bypass the first filter across a signal path, and the second mode is configured to apply the first filter across the signal path;
an amplifier having an input selectively coupled to an output of the antenna tuner; and
a second filter having an output selectively coupled to the amplifier.

14. The RF chain circuit of claim 13, further comprising a second set of switches coupled to at least the second filter, wherein the second set of switches is configured to switch among at least the first mode and the second mode, wherein the first mode further bypasses the second filter between the antenna tuner and the amplifier, and the second mode further couples the output of the second filter to input of the amplifier.

15. The RF chain circuit of claim 13, further comprising a circuit package comprising the first filter and the antenna tuner.

16. A method of suppressing a jammer signal in a radio frequency (RF) receive chain circuit:
outputting, in response to detecting a jammer signal, a first control signal that triggers a first set of switches to switch from a first mode to a second mode; and
filtering a signal using a first filter while the first set of switches is in the second mode, wherein the first filter comprises at least one reactive component, wherein an antenna tuner comprises a capacitor bank selectively coupled in parallel with the at least one reactive component, and wherein the first set of switches is coupled to at least the first filter.

17. The method of claim 16, wherein filtering the signal comprises suppressing at least one harmonic frequency associated with a local oscillator frequency, wherein the at least one reactive component comprises a first inductive component and a first capacitive component, and the first inductive component is coupled in parallel with the first capacitive component.

18. The method of claim 17, wherein:
the first set of switches comprises:
a first switch coupled between a first node and a second node;
a second switch coupled to at least the second node;
a third switch coupled between the first node and a first terminal of the first inductive component; and
a fourth switch coupled between a second terminal of the first inductive component and the second switch, the second switch being coupled between the second node and the fourth switch; and
outputting the first control signal comprises outputting the first control signal that is configured to close the first switch, the third switch, and the fourth switch and open the second switch in response to detecting the jammer signal in a received signal.

19. The method of claim 18, further comprising:
outputting, in response to detecting a received signal without any jammer signal, a second control signal that triggers the first set of switches to switch from the second mode to the first mode, the second control signal being configured to open the first switch, the third switch, and the fourth switch and close the second switch; and
bypassing the first filter while the first set of switches is in the first mode.

20. The method of claim 18, further comprising:
outputting a second control signal that is configured to close a fifth switch in response to detecting a received signal at a frequency less than or equal to a threshold; or
outputting a third control signal that opens the fifth switch in response to detecting the received signal at a frequency greater than the threshold, wherein the first set of switches comprises the fifth switch coupled between the fourth switch and a reference potential node, wherein the at least one reactive component further comprises a second capacitive component coupled between the second terminal of the first inductive component and the reference potential node.
